(19) United States
(12) Patent Application Publication
(10) Pub. No.: US 2014/0058738 A1
(43) Pub. Date: Feb. 27, 2014

(54) PREDICTIVE ANALYSIS FOR A MEDICAL TREATMENT PATHWAY

(71) Applicant: Filip J. Yeskel, Raleigh, NC (US)

(72) Inventor: Filip J. Yeskel, Raleigh, NC (US)

(73) Assignee: INTERNATIONAL BUSINESS MACHINES CORPORATION, Armonk, NY (US)

(21) Appl. No.: 13/590,293

(22) Filed: Aug. 21, 2012

(51) Int. Cl. G06F 19/00

(52) U.S. Cl. CPC G06F 19/3437
USPC 705/2

(57) ABSTRACT

Embodiments disclosed herein provide predictive analysis of medical treatment pathways to assist healthcare providers and/or patients determine the statistical probability of a treatment outcome, among the experience of a large patient and provider population, of a particular treatment step along a defined treatment pathway for a specific patient of interest. Specifically, a plurality of predictive models, based on data from a large and demographically similar patient population, are created for a plurality of treatment paths stemming from a selected treatment node within a medical treatment pathway of a clinical guideline. Medical data for the patient of interest is input to the plurality of predictive models, and model generated treatment outcome probabilities for the patient of interest are generated and compared for each of the plurality of treatment paths stemming from the selected treatment node.

### BACKGROUND

1. Technical Field

This invention relates generally to decision support for clinical decisions in a range of medical disciplines and, more specifically, to predictive analytics for determining the probability of a treatment outcome at a point along a medical treatment pathway.

2. Related Art

When patients are seen, treated, or tested by medical practitioners and technicians, the events of the interaction are recorded and become part of the medical records of the patient. Maintenance of these medical records for a patient is an essential part of modern medical treatment of the patient. Recently, the technology of recording and archiving medical records has undergone a dramatic evolution. Instead of the previous bulky paper recording systems, modern medical and health care institutions are adopting electronic medical records systems. Such computerized record keeping systems offer significant advantages to the practitioners and to the patient, as well as to the health care system as a whole.

Electronic medical records systems are typically accessible by clinical service providers from throughout the health care institution without the need for tracking down a particular paper file. Electronic medical records provide a centralized repository of the health care records of the patient, thus making it easier for all professionals seeing the patient to be aware of particular medical conditions, and avoiding the need to transfer paper files around the institution. From the viewpoint of the health care institution, electronic capture and analysis of a patient visit, diagnosis, treatment and results information makes possible the realistic evaluation of clinical outcomes in view of any desired input parameter. Thus the use of electronic medical records continues to rapidly grow.

Many medical and health care institutions also maintain a set of clinical practice guidelines for the benefit of health care providers. Clinical practice guidelines are well-established sequences intended for healthcare providers to diagnose and treat medical conditions. Once a physician has completed the diagnosis and determined the prognosis, the physician proposes a treatment plan, e.g., according to the clinical guidelines provided by the medical field on the treatment of the particular condition. These guidelines are typically the product of long-term clinical studies, the results of which are peer reviewed and published in established medical journals. Thus the development of treatment guidelines for a specific condition is a long, complex, and expensive process that is typically undertaken for a necessarily limited number of conditions.

When, as often happens, a patient presents with a set of signs and symptoms that are not a perfect fit to the guideline basis, the physician must rely on his/her professional judgment to bridge the gap to determine whether and to what extent the treatment guidelines actually apply. As more vagaries in human physiology become measurable and, therefore, part of the consideration, the determination of the applicability of a given treatment plan to a specific individual becomes increasingly complex. Current art approaches generally require physicians to consult among themselves when presented with treatment uncertainty for complex treatment plans. However, the consultation between no more than a few colleagues, physicians, experts, etc., imposes severe limits on the value to this current art approach.

### SUMMARY

In general, embodiments disclosed herein provide approaches for predictive analysis of a medical treatment pathway to assist a healthcare provider determine the statistical probability of a treatment outcome, among the experience of a large patient and provider population, of a particular treatment step along a defined treatment pathway for a selected patient of interest. Specifically, a plurality of predictive models, based on data from a large and demographically similar patient population, are created for a plurality of treatment paths stemming from a selected treatment node within a medical treatment pathway of a clinical guideline. Medical data for the patient of interest is then input to the plurality of predictive models, to determine a probability of a treatment outcome for the patient of interest for each of the plurality of treatment paths stemming from the selected treatment node. Treatment uncertainty is thereby reduced by providing an indication of outcome probability for each medical treatment pathway option.

One aspect of the present invention includes a method for predictive analysis of a medical treatment pathway, comprising the computer-implemented steps of: selecting a treatment node from the medical treatment pathway of a clinical guideline; generating a plurality of predictive models for a plurality of treatment paths stemming from the treatment node; inputting medical data for a patient of interest to each of the plurality of predictive models to generate a probability of each of a set of proposed treatment outcomes; and analyzing the probability of each of the set of proposed treatment outcomes for the patient of interest for each of the plurality of treatment paths stemming from the treatment node.

Another aspect of the present invention provides a system for predictive analysis of a medical treatment pathway, the system comprising: a memory medium comprising instructions; a bus coupled to the memory medium; and a processor coupled to a predictive analysis system via the bus that when executing the instructions causes the system to: select a treatment node from the medical treatment pathway of a clinical guideline; generate a plurality of predictive models for a plurality of treatment paths stemming from the treatment node; input medical data for a patient of interest to each of the plurality of predictive models to generate a probability of each of a set of proposed treatment outcomes; and analyze the probability of each of the set of proposed treatment outcomes for the patient of interest for each of the plurality of treatment paths stemming from the treatment node.

Another aspect of the present invention provides a computer-readable storage medium storing computer instructions, which, when executed, enables a computer system to provide predictive analysis of a medical treatment pathway, the computer instructions comprising: selecting a treatment node from the medical treatment pathway of a clinical guideline; generating a plurality of predictive models for a plurality of treatment paths stemming from the treatment node; inputting medical data for a patient of interest to each of the plurality of predictive models to generate a probability of each of a set of proposed treatment outcomes; and analyzing the probability of each of the set of proposed treatment outcomes for the patient of interest for each of the plurality of treatment paths stemming from the treatment node.

Another aspect of the present invention provides a method for predictive analysis of a medical treatment pathway, the method comprising: selecting, by a computer system, a treatment node from the medical treatment pathway of a clinical guideline; generating, by the computer system, a plurality of predictive models for a plurality of paths stemming from the treatment node; inputting, by the computer system, medical data for a patient of interest to each of the plurality of predictive models to generate a probability of each of a set of proposed treatment outcomes; and analyzing, by the computer system, the probability of each of the set of proposed treatment outcomes for the patient of interest for each of the plurality of treatment paths stemming from the treatment node.

### BRIEF DESCRIPTION OF THE DRAWINGS

These and other features of the invention will be more readily understood from the following detailed description of the various aspects of the invention taken in conjunction with the accompanying drawings in which:

FIG. 1 shows a schematic of an exemplary computing environment according to illustrative embodiments;

FIG. 2 shows a schematic of an exemplary clinical guideline and medical treatment pathway according to illustrative embodiments;

FIG. 3 shows a schematic of a predictive analysis system according to illustrative embodiments;

FIG. 4 shows a schematic of a model generator according to illustrative embodiments; and

FIG. 5 shows an example matrix of treatment outcome probabilities according to illustrative embodiments; and

FIG. 6 shows a process flow for providing predictive analysis of a medical treatment pathway according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. Embodiments disclosed herein provide approaches for predictive analysis of a medical treatment pathway to assist a healthcare provider determine the statistical probability of a treatment outcome, among the experience of a large patient and provider population, of a particular treatment step along a defined treatment pathway for a specific patient of interest. Specifically, a plurality of predictive models, based on data from a large and demographically similar patient population, are created for a plurality of treatment paths stemming from a selected treatment node within a medical treatment pathway of a clinical guideline. Medical data for the patient of interest is then input to the plurality of predictive models to determine a probability of a treatment outcome for the patient of interest for each of the plurality of treatment paths stemming from the selected treatment node. Treatment uncertainty is thereby reduced by providing an indication of whether to proceed along a selected medical treatment pathway based on the probability of the treatment outcome.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

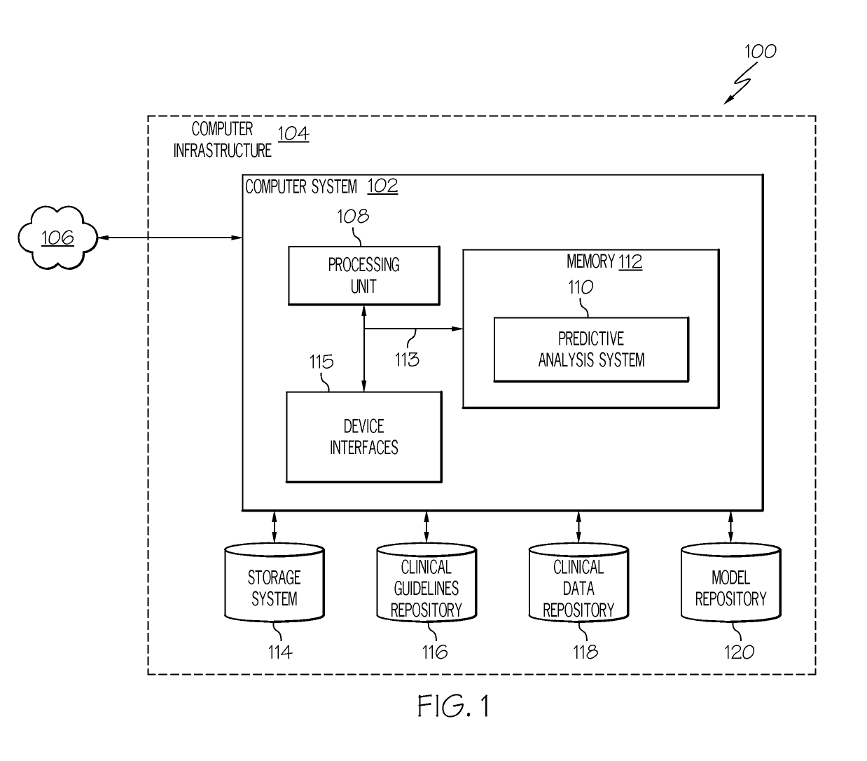

With reference now to the figures, FIG. 1 depicts a system 100 that facilitates predictive analysis of a medical treatment pathway. System 100 includes computer system 102 deployed within a computer infrastructure 104. This is intended to demonstrate, among other things, that embodiments can be implemented within a network environment 106 (e.g., the Internet, a wide area network (WAN), a local area network (LAN), a virtual private network (VPN), etc.), or on a stand-alone computer system. Still yet, computer infrastructure 104 is intended to demonstrate that some or all of the components of system 100 could be deployed, managed, serviced, etc., by a service provider who offers to implement, deploy, and/or perform the functions of the present invention for others.

Computer system 102 is intended to represent any type of computer system that may be implemented in deploying/realizing the teachings recited herein. In this particular example, computer system 102 represents an illustrative system for providing predictive analysis of a medical treatment pathway. It should be understood that any other computers implemented under various embodiments may have different components/software, but will perform similar functions. As shown, computer system 102 includes a processing unit 108 capable of operating with a predictive analysis system 110 stored in a memory unit 112 to provide predictive analysis for a medical treatment pathway, as will be described in further detail below. Also shown is a bus 113, and device interfaces 115.

Processing unit 108 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 108 receives signals transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 108 executes computer program code, such as program code for operating predictive analysis system 110, which is stored in memory unit 112 and/or storage system 114. While executing computer program code, processing unit 108 can read and/or write data to/from memory unit 112 and storage system 114, as well as a clinical guidelines repository 116, a clinical data repository 118, and a model repository 120. Storage system 114, clinical guidelines repository 116, clinical data repository 118, and model repository 120 can include VCRs, DVRs, RAID arrays, USB hard drives, optical disk recorders, flash storage devices, and/or any other data processing and storage elements for storing and/or processing data. Although not shown, computer system 102 could also include I/O interfaces that communicate with one or more hardware components of computer infrastructure 104 that enable a user to interact with computer system 102 (e.g., a keyboard, a display, camera, etc.).

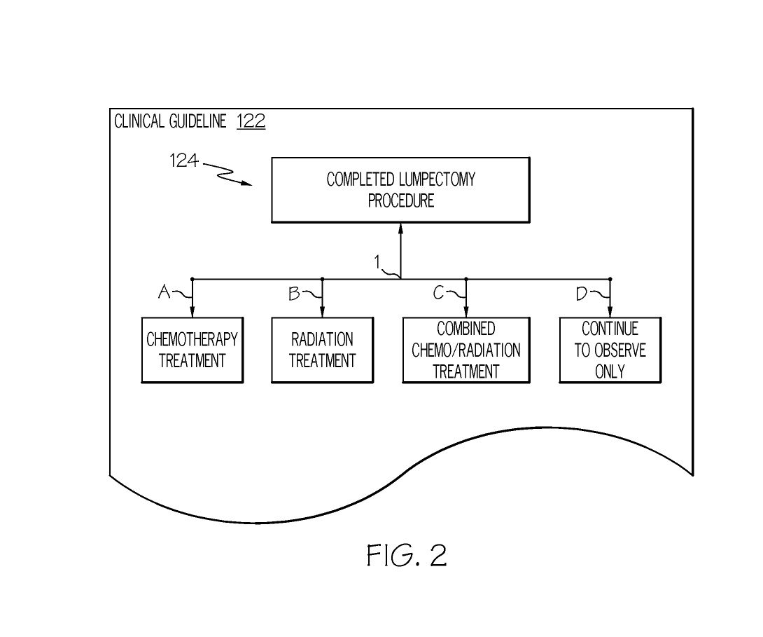

Referring now to FIG. 2, an exemplary clinical guideline 122 will be described in greater detail. As illustrated, clinical guideline 122 comprises a medical treatment pathway 124 typically used by medical professionals and medical applications to structure/standardize a care process. In this example, treatment pathway 124 follows a flowchart-style path containing many decision nodes, associated branches, and treatment recommendations at each node. Although the phrase “medical treatment pathway” has been employed, it should be understood that other similar phrases can be used. Such phrases include, but are not limited to: “critical path,” “care path,” “critical care path,” and “care map.” In this non-limiting example, medical treatment pathway 124 represents a simplified portion of a treatment pathway for treating Stage I breast cancer. As shown, a patient has completed a lumpectomy procedure and is faced with a set of treatment options at node 1 of medical treatment pathway 124. For example, treatment option A corresponds to a chemotherapy treatment pathway, treatment option B corresponds to a radiation treatment pathway, treatment option C corresponds to a combined chemotherapy and radiation treatment pathway, and treatment option D corresponds to a “wait and see” treatment pathway in which the patient and/or medical personnel continue to observe only.

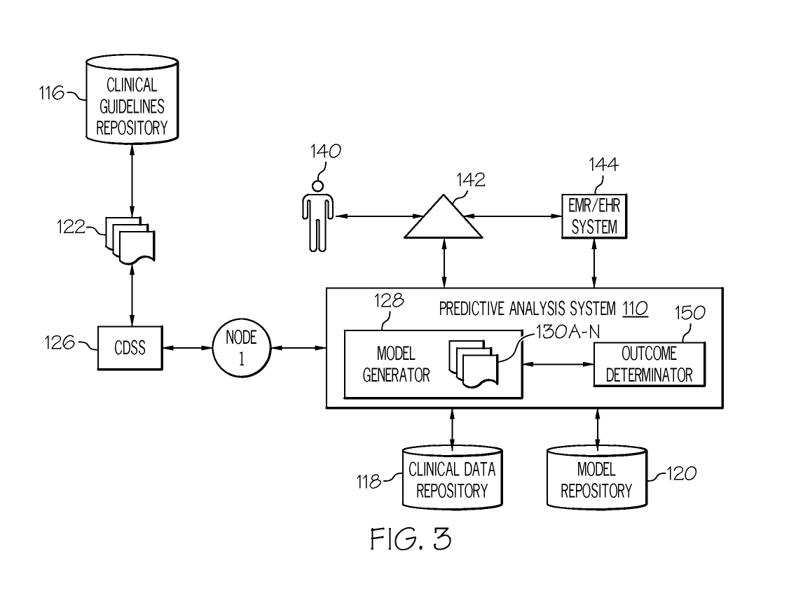

As shown in FIG. 3, during operation, clinical guideline 122 is selected from clinical guidelines repository 116 via a clinical decision support system (CDSS) 126. Clinical guideline 122 is preferably encoded into a representation (e.g., computer readable code) that can be logically interpreted by CDSS 126. CDSS 126 reads the clinical guideline 122 from clinical guidelines repository 116, or any other similar data storage source, and extracts the execution paths that can be taken by the CDSS 126 during guideline execution. In one embodiment, clinical guideline 122 is converted to an internal canonical form, which is used during guideline execution. CDSS 126 can read or can be adapted to read guidelines in several types of representational formats (e.g., XML, Protégé ontology format, etc.). Further, if a new guideline format or encoding is introduced, CDSS 126 can be updated to allow it to work with the guideline in the new form. CDSS 126 may perform these actions using an engine access interface (not shown).

A treatment node (e.g., node 1) is then selected from medical treatment pathway 124 for model generation and subsequent analysis. To accomplish this, predictive analysis system 110 comprises a model generator 128 configured to receive an output from CDSS 126 and generate a plurality of predictive models 130A-N for each respective path A, B, C, and D (FIG. 2) stemming from treatment node 1. Model generator 128 applies predictive root cause analysis, natural language processing and built-in medical terminology support to identify trends, patterns and deviations that reveal clinical and operational insights. In exemplary embodiments, a data mining function of model generator 128 analyzes patient data records stored in clinical data repository 118, or some other form of data storage facility. Although a single clinical data repository 118 is shown in for storing the guidelines, the data analyzed by model generator 128 could be spread out among numerous data repositories or numerous other database systems. As described in greater detail below, model generator 128 uses patient demographic information of patient 140 from EMR/HER system 144 to build a cohort of clinically similar patients from clinical data repository 118. Predictive models 130A-N are generated from this cohort of clinically similar patients.

In one embodiment, the data mining function of model generator 128 is executed using a particular model specification. This model specification typically indicates which input data to analyze from clinical data repository 118, which pattern-finding algorithm (such as a neural network, decision tree, etc.) to use for the analysis, how to partition the data, how to assess the results from the analysis, etc. The resulting analysis that is generated by the data mining function when executed according to the specification comprises predictive models 130A-N. As generated, predictive models 130A-N define a set of attributes related to the run of a data mining application or other type of statistical-related software application. For example, the attributes include the location of the input data, the scoring code, the fit statistics, and so on. However, it should be understood that predictive models 130A-N may be generated by applications other than a data mining application, such as by a statistical modeling software application.

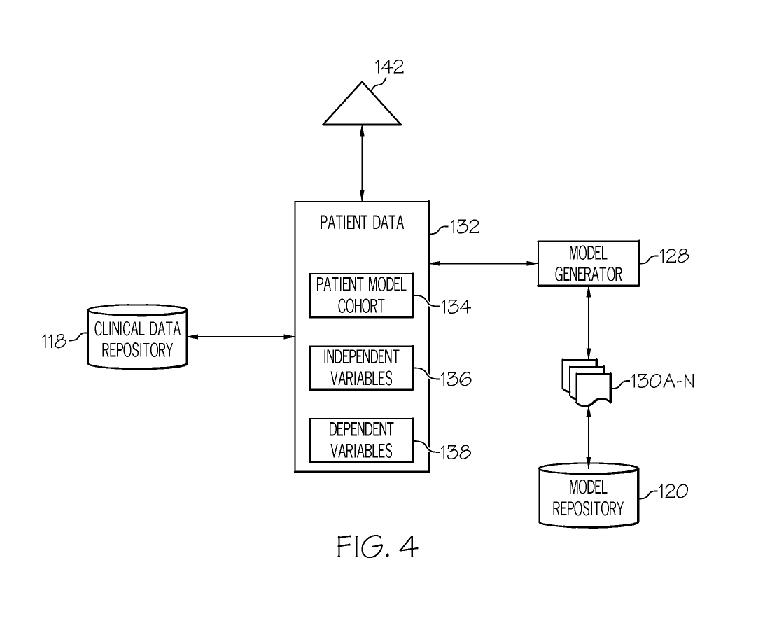

As shown in FIG. 4, patient data 132 is received from a set of data sources, e.g., clinical data repository 118, which may be a hospital data warehouse containing medical information for tens of thousands or hundreds of thousands of patients. A patient model cohort 134 is selected from patient data 132, wherein patient model cohort 134 represents a set of patients selected based on clinical and demographic similarity to medical data 142 of patient 140.

Next, a number of independent variables 136 are selected from patient data 132 for model cohort 134. Independent variables 136 are received from clinical data repository 118 and input to model generator 128. Independent variables 136 may include, but are not limited to, patient clinical (phenotypic and genotypic) information, smoking habits, occupation, health history, number of children, residence location, etc. Independent variables 136 are then correlated to a set of dependent variables 138 corresponding to one or more treatment outcomes, e.g., a disease progression. That is, model generator 128 generates each model 130A-N having a structure in which dependent variables 138 predict the probability of treatment outcomes for each treatment path (i.e., each treatment choice) based on a new patient's value for independent variables 136. For example, models 130A-N may enable the prediction of the probability of tumor recurrence for each of four possible treatments, as well as the probability of mortality within five years from a treatment date for each of the four possible treatments.

Models 130A-N are then finalized and stored in model repository 120. In one embodiment, model repository 120 is a structure that may be organized into a plurality of levels, including a project level, a diagram level, and a model level. The project level may include one or more diagrams, each of which describes a particular set of model specifications. Each diagram may then be associated with one or more models. The model repository may also include one or more index data structures for storing attributes of the models within model repository 120. These indexes may include a main index that describes the attributes of all the models stored in the model repository, and one or more special indexes, such as a tree-type index and mini-index, that describe the attributes of a particular sub-set of the models stored in the model repository. A user may then search through the one or more indexes in order to find a model that suits his or her needs. Alternatively, predictive analysis system 110 automatically queries model repository 120 in order to find and extract information from a particular model stored therein.

Referring again to FIG. 3, selected medical data (i.e., a set of relevant patient particulars) 142 is then input to predictive model 130 for patient 140, e.g., from electronic medical records (EMR) or electronic health record (EHR) system 144. Medical data 142 may comprise any number of particulars specific to patient 140 including, but not limited to patient age, smoking habits, occupation, general health history, number of children, residence location, etc. Predictive analysis system 110 comprises an outcome determinator 150 configured to analyze the probability of each proposed treatment outcome for patient 140 using each predictive model 130A-N to determine a probability of the treatment outcome (e.g., probability of cancer remission) for each treatment path stemming from treatment node 1. That is, outcome determinator 150 fits each predictive model 130A-N against medical data 142 for patient 140 and determines the probability of the particular selected outcome for patient 140 for each treatment path, e.g., A, B, C, and D, through node 1 (FIG. 2).

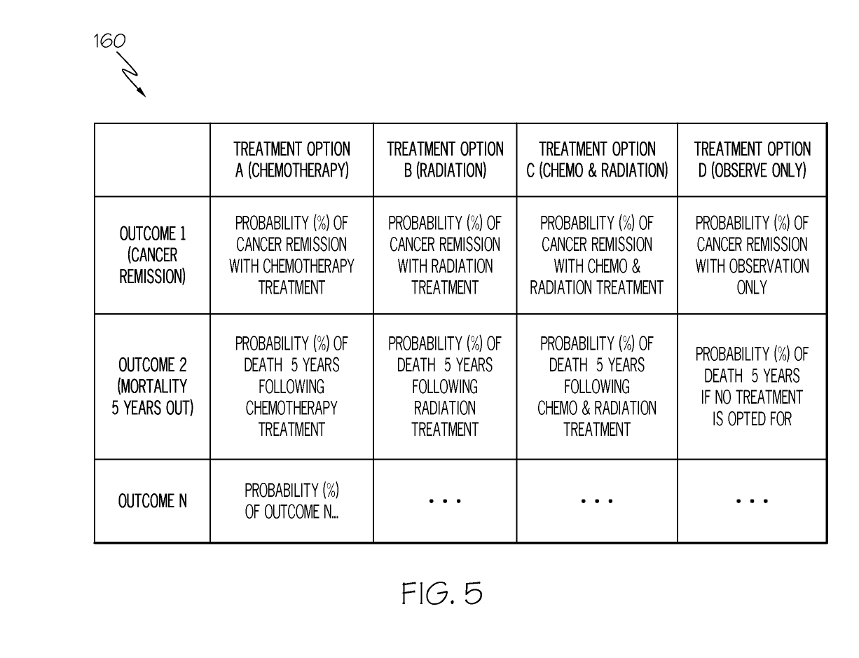

In one embodiment, outcome determinator 150 is configured to quantify the probability of the treatment outcome for patient 140 for each treatment path stemming from the treatment node. For example, the treatment outcome may be compared to the mean, as determined by predictive model 130, for a given condition and patient phenotype. If the probability of the treatment outcome is within a defined acceptable deviation from the mean, outcome determinator 150 returns an indication (e.g., expressed as a percentage of deviation from the mean) of the statistical probability of a particular outcome, for a specific set of patient parameters, in continuing with the proposed treatment decision and proceeding along the selected pathway. However, if the probability of the treatment outcome deviates from the mean beyond an acceptable amount, the proposed treatment is considered less beneficial, and another treatment option may be considered. The determined probabilities for each treatment outcome for each path stemming from the treatment node may then be compared to assist the clinician and/or patient with a determination of whether to proceed with a treatment decision. For example, the probabilities may be compared and presented visually, e.g., in a chart or matrix 160, as shown in FIG. 5, to aid the clinician and/or patient in identifying and understanding suitable treatment paths for a wide variety of treatment outcomes.

It can be appreciated that the approaches disclosed herein can be used within a computer system to provide predictive analysis for a medical treatment pathway. Predictive analysis system 110 provides mechanism for predicting the likelihood of an outcome at each desired node along medical treatment pathways for patients based on an existing corpus of data for individuals who have already traveled the relevant portion of the pathway. With a sufficient corpus of previous patient data, techniques can be applied to predict the likelihood that a given patient, with a given set of characteristics, at a given point on the treatment pathway, will, with a proposed treatment, progress to the next step along the treatment pathway. This process represents a synthetic but functional equivalent of the physician “peer consultation.” A quantification (e.g., a “confidence factor”) can be produced via analytics applied in near-real time to designate the probability of a particular outcome for the point on the treatment pathway. In exemplary embodiments, predictive analysis system 110 can be provided, and one or more systems for performing the processes described in the invention can be obtained and deployed to computer infrastructure 104. To this extent, the deployment can comprise one or more of (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computer system 102 may be described in the general context of computer-executable instructions, such as program modules, being executed by a computer. Generally, program modules include routines, programs, people, components, logic, data structures, and so on, that perform particular tasks or implement particular abstract data types. Exemplary computer system 102 may be practiced in distributed computing environments where tasks are performed by remote processing devices that are linked through a communications network. In a distributed computing environment, program modules may be located in both local and remote computer storage media including memory storage devices.

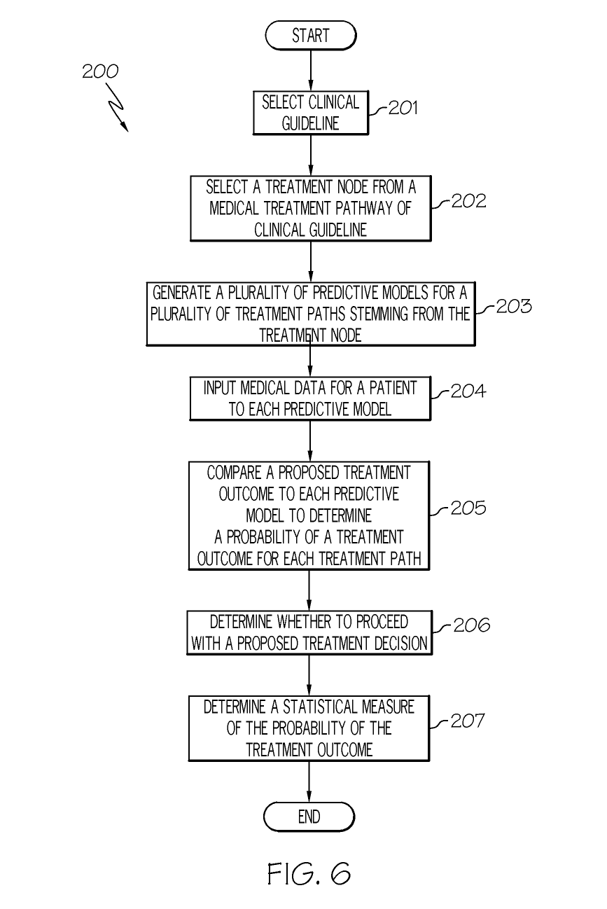

As depicted in FIG. 6, computer system 102 carries out the methodologies disclosed herein. Shown is a method 200 for predictive analysis of a medical treatment pathway. At 201, an encoded clinical guideline is selected based on its appropriateness for treating a given medical condition. At 202, a treatment node from the medical treatment pathway of the clinical guideline is selected. At 203, a predictive model is generated for each treatment path stemming from the treatment node. At 204, medical data for a patient is input to each of the predictive models. At 205, a treatment outcome is compared to each of the predictive models to determine a probability of the treatment outcome for the patient of interest for each treatment path stemming from the treatment node. At 206, it is determined whether to proceed with a proposed treatment decision based on the probability of the treatment outcome for the patient of interest for each treatment path stemming from the treatment node. Finally, at 207, a statistical measure of the probability of the treatment outcome is determined based on the comparison of the treatment outcome to the predictive model, and method 200 ends.

The flowchart of FIG. 6 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, as will be described herein, systems/components may also be implemented as a combination of software and one or more hardware devices. For instance, predictive analysis system 110, including model generator 128 and outcome determinator 150, may be embodied in the combination of a software executable code stored on a memory medium (e.g., memory storage device). In a further example, a system or component may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

For example, an implementation of exemplary computer system 102 (FIG. 1) may be stored on or transmitted across some form of computer-readable storage medium. Computer-readable storage medium can be media that can be accessed by a computer. “Computer-readable storage medium” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication medium” typically embodies computer readable instructions, data structures, and program modules. Communication media also includes any information delivery media.

It is apparent that there has been provided an approach for clinical decision support via predictive analysis of next step treatment outcome along a medical treatment pathway. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for predictive analysis of a medical treatment pathway, the method comprising the computer-implemented steps of:
selecting a treatment node from the medical treatment pathway of a clinical guideline;
generating a plurality of predictive models for a plurality of treatment paths stemming from the treatment node;
inputting medical data for a patient of interest to each of the plurality of predictive models to generate a probability of each of a set of proposed treatment outcomes; and
analyzing the probability of each of the set of proposed treatment outcomes for the patient of interest for each of the plurality of treatment paths stemming from the treatment node.

2. The method according to claim 1, further comprising the computer-implemented step of determining whether to proceed with a treatment decision based on the probability of the treatment outcome for the patient of interest for each of the plurality of treatment paths stemming from the treatment node.

3. The method according to claim 1, the computer-implemented step of generating the plurality of predictive models comprising:
receiving patient data from a set of data sources;
selecting a patient model cohort from the patient data;
selecting a set of independent variables from the patient data for the patient model cohort; and
correlating a set of dependent variables to the set of independent variables.

4. The method according to claim 1, further comprising the computer-implemented step of receiving the medical data for the patient from a medical health record.

5. The method according to claim 1, further comprising the computer-implemented step of quantifying the probability of the treatment outcome for the patient of interest for each of the plurality of treatment paths stemming from the treatment node.

6. The method according to claim 1, further comprising the computer-implemented step of comparing each of the probabilities of the treatment outcome for the patient of interest for each of the plurality of treatment paths stemming from the treatment node.

7. A system for predictive analysis of a medical treatment pathway, the system comprising:
a memory medium comprising instructions;
a bus coupled to the memory medium; and
a processor coupled to a predictive analysis system via the bus that when executing instructions causes the system to:
select a treatment node from the medical treatment pathway of a clinical guideline;
generate a plurality of predictive models for a plurality of treatment paths stemming from the treatment node;
input medical data for a patient of interest to each of the plurality of predictive models to generate a probability of each of a set of proposed treatment outcomes; and
analyze the probability of each of the set of proposed treatment outcomes for the patient of interest for each of the plurality of treatment paths stemming from the treatment node.

8. The system according to claim 7, further comprising instructions causing the system to determine whether to proceed with a treatment decision based on the probability of the treatment outcome for the patient of interest for each of the plurality of treatment paths stemming from the treatment node.

9. The system according to claim 7, the instructions causing the system to generate the plurality of predictive models further comprising instructions causing the system to:
select a patient model cohort from the patient data;
select a set of independent variables from the patient data for the patient model cohort; and
correlate a set of dependent variables to the set of independent variables.

10. The system according to claim 7, further comprising computer instructions causing the system to receive the medical data for the patient from a medical health record.

11. The system according to claim 7, further comprising computer instructions causing the system to quantify the probability of the treatment outcome for the patient of interest for each of the plurality of treatment paths stemming from the treatment node.

12. The method according to claim 7, further comprising computer instructions causing the system to compare each of the probabilities of the treatment outcome for the patient of interest for each of the plurality of treatment paths stemming from the treatment node.

13. A computer-readable storage medium storing computer instructions, which when executed, enables a computer system to provide predictive analysis of a medical treatment pathway, the computer instructions comprising:
selecting a treatment node from a medical treatment pathway of a clinical guideline;
generating a plurality of predictive models for a plurality of treatment paths stemming from the treatment node;
inputting medical data for a patient of interest to each of the plurality of predictive models to generate a probability of each of a set of proposed treatment outcomes; and
analyzing the probability of each of the set of proposed treatment outcomes for the patient of interest for each of the plurality of treatment paths stemming from the treatment node.

14. The computer-readable storage medium according to claim 13 further comprising computer instructions for determining whether to proceed with a treatment decision based on the probability of the treatment outcome for the patient of interest for each of the plurality of treatment paths stemming from the treatment node.

15. The computer-readable storage medium according to claim 13, the computer instructions for generating the plurality of predictive models comprising:
receiving patient data from a set of data sources;
selecting a patient model cohort from the patient data;
selecting a set of independent variables from the patient data for the patient model cohort; and
correlating a set of dependent variables to the set of independent variables.

16. The computer-readable storage medium according to claim 13, further comprising computer instructions for receiving the medical data for the patient from a medical health record.

17. The computer-readable storage medium according to claim 13, further comprising computer instructions for quantifying the probability of the treatment outcome for the patient of interest for each of the plurality of treatment paths stemming from the treatment node.

18. The computer-readable storage medium according to claim 13, further comprising computer instructions for comparing each of the probabilities of the treatment outcome for the patient of interest for each of the plurality of treatment paths stemming from the treatment node.

19. A method for providing predictive analysis of a medical treatment pathway, the method comprising:
selecting, by a computer system, a treatment node from a medical treatment pathway of a clinical guideline;
generating, by the computer system, a predictive model for each of a set of paths stemming from the treatment node;
inputting, by the computer system, medical data for a patient of interest to each of the plurality of predictive models to generate a probability of each of a set of proposed treatment outcomes; and
analyzing, by the computer system, the probability of each of the set of proposed treatment outcomes for the patient of interest for each of the plurality of treatment paths stemming from the treatment node.

20. The method according to claim 19, further comprising determining, by the computer system, whether to proceed with a treatment decision based on the probability of the treatment outcome for the patient of interest for each of the plurality of treatment paths stemming from the treatment node.

21. The method according to claim 19, the generating, by the computer system, the plurality of predictive models for the treatment node, comprising:
receiving patient data from a set of data sources;
selecting a patient model cohort from the patient data;
selecting a set of independent variables from the patient data for the patient model cohort; and
correlating a set of dependent variables to the set of independent variables.

22. The method according to claim 19 further comprising receiving, by the computer system, the medical data for the patient from a medical health record.

23. The method according to claim 19 further comprising quantifying, by the computer system, the probability of the treatment outcome for the patient of interest for each of the plurality of treatment paths stemming from the treatment node.

24. The method according to claim 19 further comprising comparing, by the computer system, each of the probabilities of the treatment outcome for the patient of interest for each of the plurality of treatment paths stemming from the treatment node.
